(19) United States
(12) Patent Application Publication
(10) Pub. No.: US 2016/0226146 A1
(43) Pub. Date: Aug. 4, 2016

(54) ANTENNA DEVICE

(71) Applicant: TDK Corporation, Tokyo (JP)

(72) Inventors: Toshifumi KOMACHI, Tokyo (JP); Hirohumi ASOU, Tokyo (JP); Toshio TOMONARI, Tokyo (JP)

(73) Assignee: TDK Corporation, Tokyo (JP)

(21) Appl. No.: 14/994,358

(22) Filed: Jan. 13, 2016

(30) Foreign Application Priority Data
Jan. 29, 2015 (JP) 2015-015392

(51) Int. Cl. H01Q 7/06; H01Q 1/24

(52) U.S. Cl. CPC H01Q 7/06; H01Q 1/241

(57) ABSTRACT

Disclosed herein is an antenna device includes a first metal layer having a first slit, an antenna coil having an inner diameter area overlapping with the first slit in planar view and a coil axis perpendicular to the first metal layer, and a first magnetic layer provided on a back surface of the first metal layer, which faces the antenna coil, and provided outside of the antenna coil in planar view. An upper surface of the first magnetic layer facing the back surface of the first metal layer is positioned closer than a far end surface of the antenna coil to the back surface of the first metal layer along the coil axis, as viewed from the back surface of the first metal layer, or is positioned in the same plane as the far end of the antenna coil.

### BACKGROUND OF THE INVENTION

1. Field of the Invention

The present invention relates to an antenna device, and particularly to an antenna device that is suitable for NFC (Near Field Communication) system. The present invention also relates to a portable electronic device in which such an antenna device is used.

2. Description of Related Art

In recent years, a RFID (Radio Frequency Identification) system is incorporated in portable electronic devices such as smartphones. As a communication means for the system, an antenna is incorporated in portable electronic devices to perform near field communication with a reader/writer or the like.

Meanwhile, a metal shield is provided in the portable electronic device in order to protect an internal circuit from external noise and prevent unnecessary radiation of noise generated inside the device. In particular, in order to make the body thinner, lighter, and more resistant to shock such as when the body is dropped, and to improve the design and other factors, the housing of a recent portable electronic device itself has increasingly been made of metal instead of resin, with the housing doubling as a metal shield. However, in general, the metal shield blocks radio waves. Therefore, an antenna needs to be placed in such a way as not to overlap with the metal shield. If the metal shield is provided across a wide range, how to dispose the antenna becomes a problem.

To solve the above problem, for example, in an antenna device disclosed in Japanese Patent No. 4,687,832, Japanese Patent Application Laid-open No. 2002-111363, or Japanese Patent Application Laid-open No. 2012-162195, an opening is formed in a conductor layer, and a slit is formed in such a way as to connect the opening to an outer edge. An antenna coil is disposed in such a way that an inner diameter area overlaps with the opening. In the antenna device, current flows through the conductor layer in such a way as to block a magnetic field generated by a flow of current through a coil conductor. Then the current flows along with the slit that flows around the opening of the conductor layer, and the current also flows around the conductor layer due to the edge effect. As a result, a magnetic field is generated from the conductor layer, and the conductor layer makes a large loop of the magnetic flux, resulting in a longer communication distance between the antenna device and an antenna that the antenna device is communicating with. That is, the conductor layer functions as an accelerator that helps to increase the antenna coil's communication distance.

However, it is demanded that the conventional antenna device described above should be further improved to increase the communication range. Particularly, the communication range will be shorter as the planer size of the metal layer of the antenna device becomes smaller. The communication range should therefore have a desirable value even if the metal layer has a small planer size.

### SUMMARY

It is therefore an object of the present invention to enhance the accelerating function of the metal layer in an antenna device, which is provided on a mobile electronic apparatus and which is used as accelerator to lengthen the communication range of the antenna coil.

To achieve the above-mentioned object, an antenna device according to the present invention comprises a first metal layer having a first slit, an antenna coil having an inner diameter area overlapping with the first slit in planar view and a coil axis perpendicular to the first metal layer,

and a first magnetic layer provided on the back surface of the first metal layer, which faces the antenna coil, and provided outside the antenna coil in planar view, wherein an upper surface of the first magnetic layer facing the back surface of the first metal layer is positioned closer than a far end of the antenna coil to the back surface of the first metal layer along the coil axis, as viewed from the back surface of the first metal layer, or is positioned in the same plane as the far end of the antenna coil.

In this invention, the first magnetic layer is provided at the back of the first metal layer and outside the antenna coil In planar view, and therefore does not overlap with the antenna coil as viewed in plane. Hence, the magnetic flux generated from the current flowing in the antenna coil and intersecting with the antenna coil can be changed in direction, and can be guided not to the first metal layer. This can suppresses the diamagnetic field and the loss of eddy current, ultimately increasing the communication range of the antenna.

In this invention, it is desired that the first magnetic layer is bonded to the back surface of the first metal layer. The first magnetic layer can thereby be easily arranged between the first metal layer and the antenna coil.

The antenna device according to the present invention preferably further comprises a second magnetic layer facing the first metal layer across the antenna coil. In most mobile electronic apparatuses, the antenna coil is mounted on a metal body such as the battery pack. If the second magnetic layer is interposed between a metal member and the antenna coil a magnetic fins path that intersects with the antenna coil can be easily provided. The influence the metal member imposes on the antenna coil can therefore be controlled. Hence, the antenna device can acquire desirable antenna characteristic.

In this indention, the first magnetic layer is preferably integrated with the second magnetic layer. Then, both the first magnetic layer and the second magnetic layer change the path of the magnetic flux generated from the current flowing in the antenna coil. The magnetic flux is therefore guided toward the inner diameter area of the antenna coil. A magnetic flux loop can therefore be formed more reliably than in the first embodiment. The communication range of the antenna can therefore be increased reliably. Further, the antenna coil and the magnetic layer can be easily positioned with respect to the slit. This can prevent the degradation of the antenna characteristic, which would be inevitable if applied to the first metal layer with possible displacement.

In this invention, it is desired that the antenna device further comprises a substrate arranged parallel to the first metal layer, wherein the antenna coil is formed on an upper surface of the substrate which opposes to the first metal layer, and the second magnetic layer is formed on a lower surface of the substrate. In this configuration, the antenna coil and the second magnetic layer can be easily forced, handled and mounted.

In this invention, it is desired that the antenna device further comprises a substrate arranged parallel to the first metal layer, wherein the antenna coil is formed on an upper surface of the substrate, the first magnetic layer is positioned not overlapping with the substrate in planar view, and an lower surface of the first magnetic layer is located below the upper surface of the substrate. This configuration enables the first magnetic layer to function as a positioning guide for the antenna coil, enhancing the mounting precision of the antenna coil with respect to the slit.

In this invention, it is desired that the antenna device further comprises a second metal layer having a second slit, wherein the second metal layer is provided opposite to the first metal layer as viewed from the antenna coil, and the inner diameter area of the antenna coil overlaps with the second slit in planar view. The magnetic flux intersecting with the antenna coil greatly extends around not only the first metal layer, but also the second, metal layer at the back, and then extends back to the inner diameter area of the antenna coil through the second slit. The loop size of the magnetic flux can therefore increase. This enhances the directivity of the antenna, ultimately further lengthening the communication range of the antenna.

In this invention, it is desired that a lower surface of the first magnetic layer is in contact with the second metal layer. If so configured, the first magnetic layer can be thick and arranged in the space between the first metal layer and the second meal layer. The first magnetic layer can therefore sufficiently suppress the generation of a diamagnetic field and the loss of eddy current.

In this invention, it is desired that the first metal layer has a first metal plate, a second metal plate located adjacent to the first metal plate, across the first slit, and a connecting portion bridging the first slit at one end thereof and connecting the first metal plate and the second metal plate, making them integral with each other. Since the connecting portion connects the first metal surface and the second metal surface in this configuration, the first and second metal surfaces can be treated as a single metal member. Hence, a cover having such metal surfaces can be easily manufactured. Further, the first metal surface and the second metal surface need not foe aligned with each other, and the width of the slit SL will never change.

In this invention, the first metal layer is preferably a housing of the mobile electronic apparatus that incorporates the antenna coil. If the housing of the mobile electronic apparatus is made of metal, not resin, and therefore functions as s metal shield, a part of the housing is used as an accelerator for the antenna coil. This helps to enhance the emission characteristic of the antenna, and ultimately to increase the communication range of the antenna coil.

In this invention, the first magnetic layer is preferably a magnetic sheet containing fiat metal grains. If the first magnetic layer contains fiat metal grains, the magnetic field emanating from the antenna coil can be orientated in the horizontal direction that intersects with the coil axis. Since polymer insulates the fiat metal particles from one another, the first magnetic layer can prevent the generation of an eddy current. The antenna device can therefore achieve both high magnetic permeability and low magnetic loss in the high RFID frequency band.

In the antenna device according to the present invention, the metal layer provided in the mobile electronic apparatus is used as accelerator to increase the communication range of the antenna coil. Therefore, the acceleration function can be enhanced.

### BRIEF DESCRIPTION OF THE DRAWINGS

The above features and advantages of the present invention will be more apparent from the following description of certain preferred embodiments taken in conjunction with the accompanying drawings, in which:

FIG. 1 is a plan view showing a configuration of an antenna device according to a first embodiment of the present invention;

FIG. 2 is a schematic cross-sectional view of the antenna device, taken along line A-A shown in FIG. 1;

FIG. 3 is a schematic plan view for explaining how the first metal layer and the first magnetic layer perform their functions;

FIG. 4 is a schematic cross-sectional view for explaining how the first metal layer and the first magnetic layer perform their functions;

FIG. 5 is a schematic cross-sectional view showing a of an antenna device according to a second embodiment of the present invention;

FIG. 6 is a schematic cross-sectional view showing a configuration of an antenna device according to a third embodiment of the present invention;

FIG. 7 is a schematic cross-sectional view showing a configuration of an antenna device according to a fourth embodiment of the present invention;

FIG. 8 is a schematic plan view showing a configuration of an antenna device according to a fifth embodiment of the present invention; and

FIG. 9 is a schematic plan view showing a configuration of an antenna device according to a sixth embodiment of the present invention.

### DETAILED DESCRIPTION OF THE EMBODIMENTS

Preferred embodiments of the present invention will be explained below in detail with reference to the accompanying drawings.

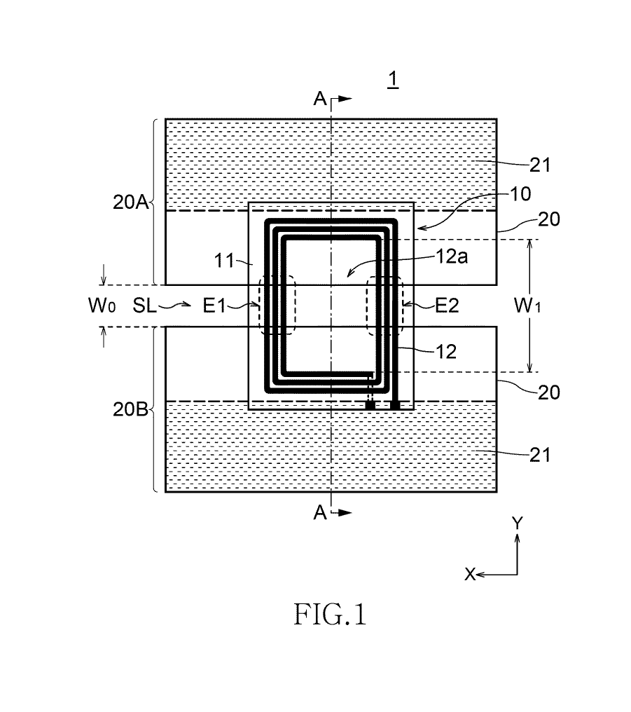

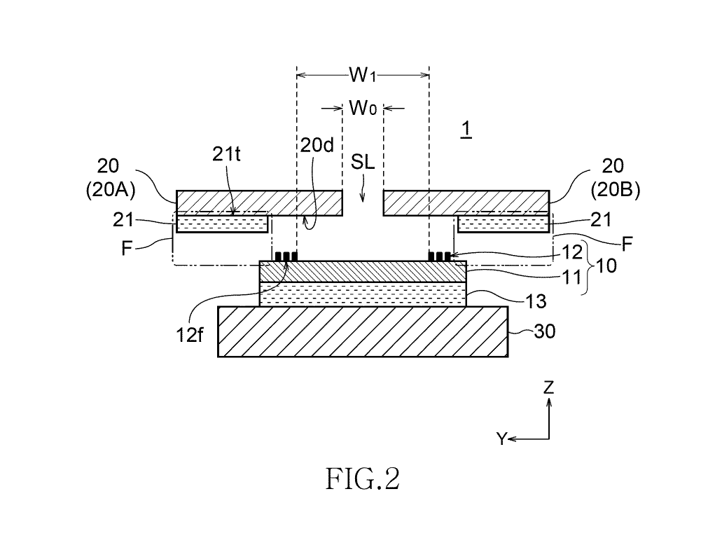

FIG. 1 is a plan view showing a configuration of an antenna device according to a first embodiment of the present invention. FIG. 2 is a schematic cross-sectional view of the antenna device, taken along line A-A shown in FIG. 1.

As shown in FIGS. 1 and 2, the antenna device 1 comprises an antenna element 10 composed of a planer loop antenna, a first metal layer 20 covering the antenna element 10, and a first magnetic layer 21 formed on a back surface of the first metal layer 20.

The antenna element 10 comprises a substrate 11 and an antenna coil 12 formed on an upper surface of the substrate 11. The substrate 11 is a flexible substrate made of, for example, PET resin, its planer size is, for example, 40×50 mm, and its thickness is, for example, 30 μm. The substrate 11 is arranged parallel to the first metal layer 20.

The antenna coil 12 is composed of a spiral pattern which is substantially rectangular, and has a coil axis which is perpendicular to the main surface of the first metal layer 20. Both ends of the spiral pattern constituting the antenna coil 12 are led to an edge of the substrate 11 by lead parts. Particularly, an inner end of the spiral pattern is led to the outside of the loops by crossing the spiral loops. Both ends of the antenna coil 12 are connected to, for example, an NFC chip (not shown). The antenna coil 12 may be formed by means of electroplating. Alternatively, it may be formed by means of etching (patterning) a metal layer formed on the entire surface of the substrate 11.

As shown in FIG. 2, a second magnetic layer 13 is formed on a lower surface of the substrate 11. In most cases, the antenna element 10 of the mobile electronic apparatus is mounted, on a surface of a battery pack 30. However, if the second magnetic layer 13 is interposed between the battery pack 30 and the antenna coil 12 as shown in FIG. 2, a passage is provided for the magnetic flux generated from the current flowing in the antenna coil. Hence, the influence the metal body of the battery pack 30 imposed on the antenna coil can be suppressed and a desirable characteristic of the antenna device can be obtained.

The first metal layer 20 is, for example, a member constituting the housing of the mobile electronic apparatus incorporating the antenna, element 10. The first metal layer 20 has therefore a larger planer size than that of the antenna coil 12, and covers almost all surface of the antenna element 10. The first metal layer 20 can be a member not integral with the housing of the mobile electronic apparatus. Preferably, the planer size of the first metal layer 20 is 4 to 5 times the planer size of the antenna coil 12, but may be about 2 times the planer size of the antenna coil 12. The smaller the planer size the first metal layer 20 has, the more its function of accelerating antenna coil 12 will decrease, inevitably shortening the communication range. Nonetheless, the first magnetic layer 21 enhances the accelerating function of the first metal layer 20, compensating for the decrease of the accelerating function resulted from the small planer size of the first metal layer 20. Hence, the antenna device can acquire a desirable communication range.

A slit SL (i.e., first slit) is formed in the first metal layer 20. The slit SL is a linear slit that extends in X direction, from one edge of the first metal layer 20 to the opposite edge thereof. The slit SL therefore divides the first metal layer 20 into two parts. The first metal layer 20 is thus composed of first and second metal plates 20A and 20B that are adjacent in Y direction, across the slit SL. The first and second metal, plates 20A and 20B are rectangular patterns, preferably having the same width in X direction. The first and second metal plates 20A and 20B need not have the same size, and may have different sizes. The slit SL need not remain void. Rather, it may be filled with resin.

As shown in FIG. 1, the antenna element 10 is so positioned that the inner diameter area 12a of the antenna coil 12 overlaps with the slit SL in planar view. To make the first and second metal plates 20A and 20B overlap with the inner diameter area 12a of the antenna coil 12 in planar view, the width W₀ of the slit SL need be smaller than the width W₁ of the inner diameter area 12a, preferably W₁/2 or less. The slit SL crosses the center of the inner diameter area 12a of the antenna coil 12, and intersects with two parts E1 and E2 of the antenna coil 12. That is, two parts of the antenna coil 12 intersect with the slit SL and are thereby exposed. Hence, the emission efficiency of the antenna device is higher than in the case where only one part of the antenna coil 12 is exposed. This can enhance the antenna characteristic.

As shown in FIG. 2, the first magnetic layer 21 is provided on the back surface of the first metal layer 20, which opposes the antenna element 10. The first magnetic layer 21 is secured to the first, metal layer 20 by means of, for example, adhesion. The first magnetic layer 21 is provided outside the antenna coil 12, and does not overlap with the antenna coil 12 or the inner diameter area 12a thereof in planar view. The first magnetic layer 21 covers particularly those parts of the first metal layer 20 which are juxtaposed in Y direction. However, the first magnetic layer 21 does not cover those parts which are juxtaposed in X direction.

The first magnetic layer 21 need not be adhered to the back surface of the first metal layer 20. The first magnetic layer 21 only need to be arranged on the space provided at the back surface 20d of the first metal layer 20 interposed between the back surface 20d of the first metal layer 20 and the plans including the mount surface Of the antenna coil 20 (i.e., upper surface of the substrate 11). In FIG. 2, the region F encircled by two-dotted, broken line is the space in which the first magnetic layer 21 can be arranged. The first magnetic layer 21 may be arranged in at least one part of the region F. In order to arrange the first magnetic layer 21 in the region F, at an appropriate position with respect to the antenna coil 12, the upper surface 21t of the first magnetic layer 21, which opposes the back surface 20d of the first metal layer 20, must be closer to the back surface 20d of the first metal layer 20 than to the far-end surface 12f of the antenna coil 12 in the axial direction of the coil, as seen from the back surface 20d of the first metal layer 20. Alternatively, the upper surface 21t of the first magnetic layer 21 must exist in the same plane as the far-end surface 12f of the antenna coil 21. Preferably, the upper surface 21t of the first magnetic layer 21 exists closer to the back surface 20d of the first metal layer 20 along the coil axis than the near-end (opposing the far-end surface 12f, i.e., the upper surface of the antenna coil 12), as viewed from the back surface 20d of the first metal layer 21.

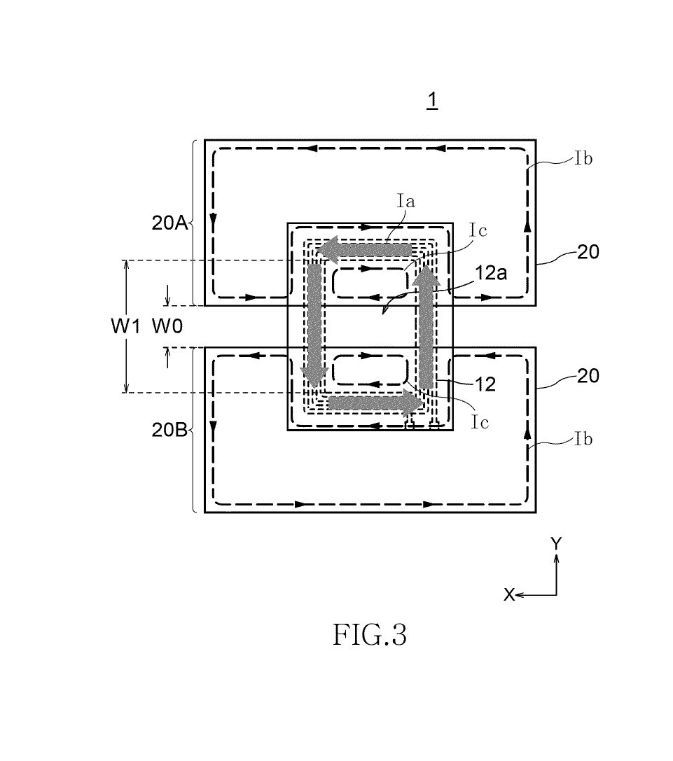

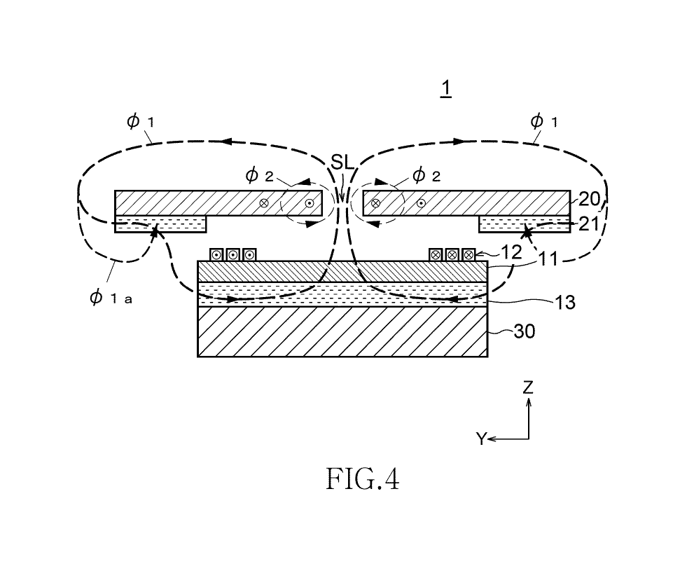

FIGS. 3 and 4 are diagrams for explaining how the first metal layer 20 and the first magnetic layer 21 perform their functions. FIG. 3 is a schematic plan view, and FIG. 4 is a schematic cross-sectional view.

As shown in FIGS. 3 and 4, when a current Ia flows counterclockwise in the antenna coil 12, a magnetic flux is generated, passing through the inner diameter area 12a of the antenna coil 12. The magnetic flux passes through the slit SL existing between the first and second metal plates 20A and 20B, and then flow around in the first and second metal plates 20A and 20B. Meanwhile, currents flow in the first and second metal plates 20A and 20B, respectively, to cancel out the magnetic flux. These currents become eddy currents Ib and Ic generated inside and outside of the antenna coil 12, respectively, by virtue of edge effect.

As shown in FIG. 4, the current Ia flowing in the antenna coil 12 generates a magnetic flux φ₁, which intersects with the antenna coil 12. The magnetic flux φ₁ is a large magnetic loop that passes through the slit SL and extends around outside the first metal layer 20. A part of the magnetic flux φ₁ passes through the first magnetic layer 21. A magnetic flux φ₂ is generated from the eddy current Ic generated in the inner diameter area 12a of the antenna coil 12, and forms a magnetic flux loop that boosts the magnetic flux φ₁.

Without the first magnetic layer 21, a part φ₁ₐ of the magnetic flux φ₁ emanating from the antenna coil 12 abuts on the back surface of the first metal layer 20, generating a diamagnetic field. The part φ₁ₐ of the magnetic flux φ₁ also results in an eddy current loss in the first metal layer 20, and cannot serve to increase the communication range of the antenna device, nonetheless, the first magnetic layer 21 guides the magnetic flux φ₁ₐ in a specific direction, not to the first metal layer 20 because the first magnetic layer 21 is provided on the back surface of the first metal layer 20 and outside the antenna coil 12. This prevents generation of a diamagnetic field that does not work to increase the communication range of the antenna device, and suppresses the eddy current loss. As a result, the communication range of the antenna device can be increased.

The first magnetic layer 21 is preferably a composite magnetic sheet made of polymer containing flat magnetic metal grains having a large aspect ratio. Like the first magnetic layer 21, the second magnetic layer 13 may foe a composite magnetic sheet. In the magnetic layer, the particles of flat metal grains overlap with one another in the thickness direction of the composite magnetic sheet, and are oriented with their planes parallel to the planer direction of the composite magnetic sheet. The composite magnetic sheet therefore has a high effective magnetic permeability with respect to its planer direction. Hence, the magnetic field generated by the antenna coil 12 can be introduced from outside into the magnetic layer to guide the magnetic flux in the horizontal direction, namely the direction intersecting at right angles with the coil axis. The particles of fiat metal grains are densely orientated in the polymer, but are insulated by the polymer. This prevents generation of an eddy current. Therefore, the antenna device can achieve both high magnetic permeability and low magnetic loss in the high RFID frequency band.

As described above, the antenna device according to this embodiment comprises an antenna coil 12 and a first metal layer 20 covering the antenna coil 12. The first metal layer 20 has a slit SL that overlaps with the inner diameter area 12a of the antenna coil 12 in planar view. Further, a first magnetic layer 21 is formed on the back surface of the first metal layer 20, which faces the antenna coil 12, and in an outside region that does not overlap with the antenna coil 21 in planar view. Therefore, the first magnetic layer 21 can prevent the generation of a diamagnetic field and a loss of eddy current in that outside region. Hence, the antenna characteristic can be enhanced to lengthen the communication range of the antenna device.

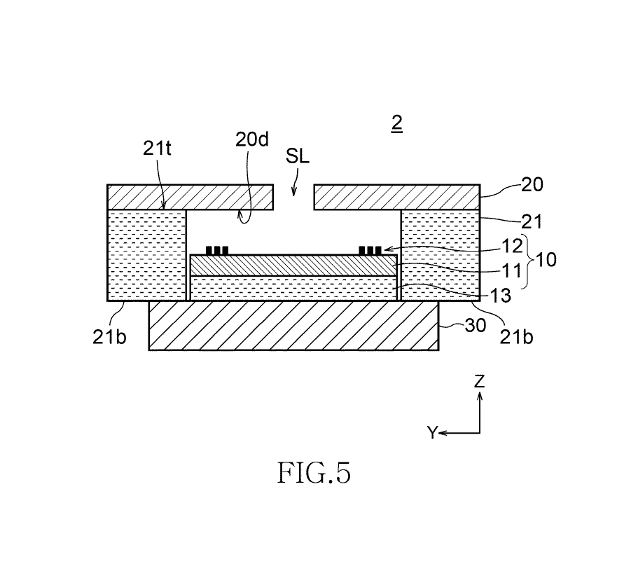

FIG. 5 is a schematic cross-sectional view showing a configuration of an antenna device according to a second embodiment of the present invention.

As shown in FIG. 5, the antenna device 2 according to this embodiment is characterized in that the first magnetic layer 21 is thicker than that in the first embodiment. The lower surface 21a of the first magnetic layer 21 is therefore lies below the upper surface of the substrate 11 (i.e., the surface on which the antenna coil 12 is formed). In this embodiment, the lower surface 21b of the first magnetic layer 21 is flush with the lower surface of the second magnetic layer 13. In any other respects, this embodiment is identical to the first embodiment in terms of configuration.

Preferably, the space in which the antenna element 10 interposed between a pair of first layers (i.e., left and right magnetic layers 21) should have a width almost equal to that of the width the substrate 11 has in Y direction. If the antenna device is so configured, the first magnetic layer 21 can be used as a guide for positioning the antenna element 10. The antenna coil 12 can be positioned with respect to the slit SL more precisely than otherwise.

In the antenna device 2 according to this embodiment, the first magnetic layer 21 is large. Therefore, many magnetic fluxes generated from the current flowing in the antenna coil 12 can be guided not to be applied to the first metal layer 20. Hence, a loop of magnetic fluxes can be formed more reliably than in the first embodiment, and the communication range of the antenna device can be reliably lengthened.

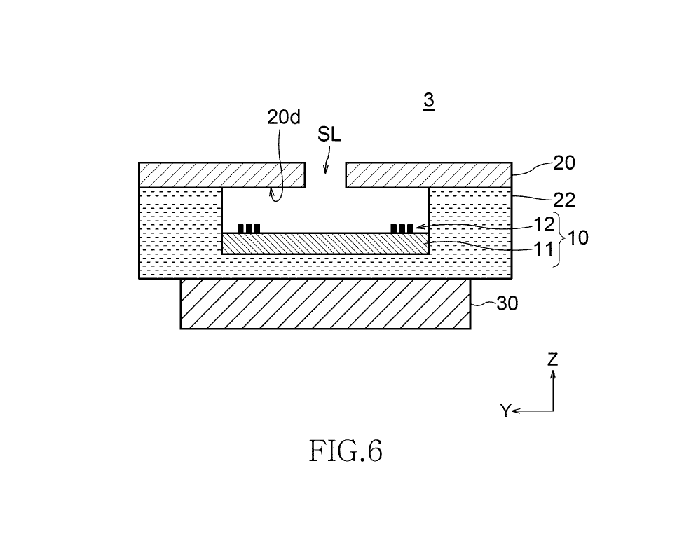

FIG. 6 is a schematic cross-sectional view showing a configuration of an antenna device according to a third embodiment of the present invention.

As shown in FIG. 6, the antenna device 3 according to this embodiment is characterized in that a first magnetic layer 21 of the type used in the first embodiment extends downwards and is integrated with the second magnetic layer 13. That is, the antenna device 3 has a magnetic layer 22 formed by integrating the first magnetic layer 21 and second magnetic layer 13 used in the first embodiment. In any other respects, the third embodiment is identical to the first embodiment in terms of configuration.

According to this embodiment, the numerous magnetic fluxes generated from the current flowing in the antenna coil 12 can be guided not to foe applied to the first metal layer 20. Hence, a loop of magnetic fluxes can be formed more reliably than in the first embodiment, and the communication range of the antenna device can be reliably lengthened. Further, the antenna element 10 and the magnetic layer 22 can be easily positioned with respect to the slit SL. The degradation of the antenna characteristic, which would otherwise occur, can therefore be prevented. Still further, this embodiment is advantageous in terms of the number of steps of arranging magnetic layers and the manufacturing cost.

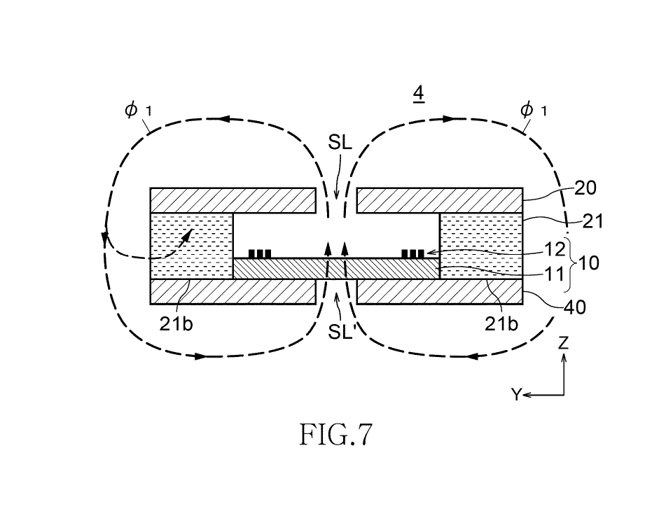

FIG. 7 is a schematic cross-sectional view showing a configuration of an antenna device according to a fourth embodiment of the present invention.

As shown in FIG. 7, the antenna device 4 according to this embodiment is characterized in that it has no members equivalent to the second magnetic layer 13 used in the first embodiment. Namely, only the first magnetic layer 21 is used in this embodiment. The first magnetic layer 21 is thick, and its lower surface 21b lies at lower position and contacts a second metal layer 40. Thus, the lower surface 21b of the first magnetic layer 21 is flush with the lower surface of the substrate 11. This embodiment has no second magnetic layer 13. Nonetheless, the magnetic path is not cut at the lower surface of the substrate 11 because the antenna element 10 is not mounted on a metal body such as the battery pack.

In this embodiment, the second metal layer 40 is provided on the back side of the antenna element 10 in place of the second magnetic layer 13 in the first embodiment. The second metal layer 40 has a slit SL′ (i.e., second slit). Like the slit SL, the slit SL′ overlaps with the inner diameter area 12a of the antenna coil 12 in planar view. The magnetic flux φ₁ intersecting the antenna coil 12 greatly extends around not only the first metal layer 20, but also the second metal layer 40 at the back, and then extends back to the inner diameter area 12a of the antenna coil 12 through the slit SL′. The loop size of the magnetic flux φ₁ can therefore increase even more. As a result, the directivity of the antenna is enhanced, increasing the communication range of the antenna even more.

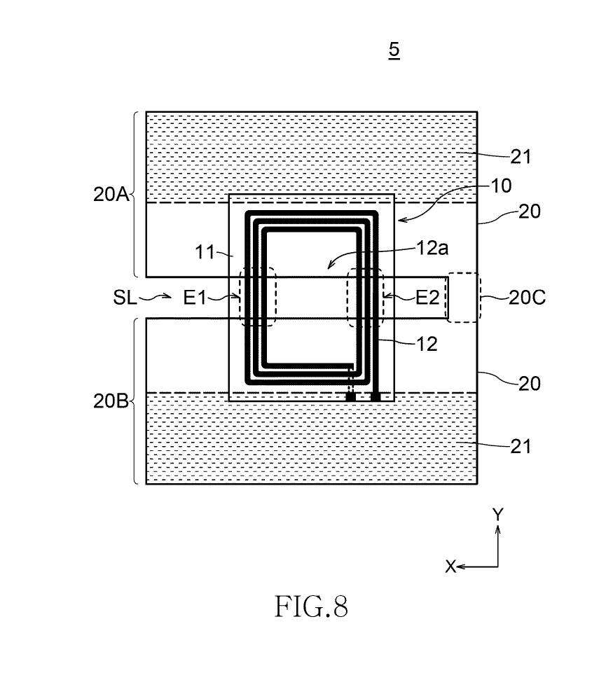

FIG. 8 is a schematic plan view showing a configuration of an antenna device 5 according to a fifth embodiment of the present invention.

As shown in FIG. 8, the antenna device 5 according to this embodiment is characterized in that the slit SL made in the first metal layer 20 does not completely divide the first metal layer 20 into two parts. Rather, the first metal layer 20 is composed of a first metal plate 20A, a second metal plate 20B and a connecting portion 20C. The first and second metal plates 20A and 20B are adjacent to each other in Y direction, across the slit SL. The connecting portion 20C bridges the slit SL and connects the first and second metal plates 20A and 20B, at one end thereof. In any other respects, this embodiment is identical to the first embodiment in terms of configuration. This embodiment may be combined with any one of the first to fourth embodiments.

The connecting portion 20C prevents the slit SL from extending in X direction to cut the metal layer completely into two parts. The connecting portion 20C exists at one end of the slit SL, filling up that end of the slit SL. The slit SL has a width uniform over its entire length. The connection part 20C has an X-direction width that is preferably one-third or less, more preferably one-fifth or less, of the X-direction width of the first and second metal plates 20A and 20B.

The first and second metal plates 20A and 20B are almost isolated by the slit SL, but are connected by the connecting portion 20C, respectively at the lower-right part and upper-right part. That is, they are not isolated physically or electrically. Hence, they can foe treated as a single metal member, and can be made by using one mold. Further, the first and the second metal plates 20A and 20b are integrated, never displaced from each other, and the width of the slit SL will never change at all.

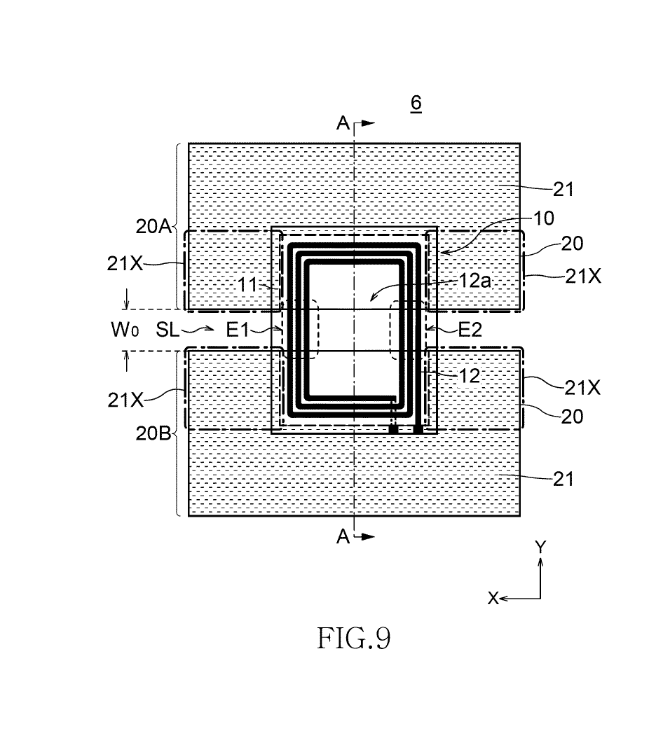

FIG. 9 is a schematic plan view showing a configuration of an antenna device according to a sixth embodiment of the present invention.

As shown in FIG. 9, the antenna device 6 according to this embodiment is characterized in that the first magnetic layer 21 is shaped like letter C as viewed in plane and is arranged outside the antenna coil 12, covering the first and second metal layers 20A and 20B almost entirely. That is, of those parts of the magnetic layer 21 which overlap with the first metal layer 20, not only the parts adjacent in Y direction as viewed from the antenna coil 12, but also the parts 21X adjacent as viewed in X direction from the antenna coil 12 are covered by the first magnetic layer 21. Thus, the first magnetic layer 21 covers a broader region than in the first embodiment, and can therefore more suppress the diamagnetic field and the loss of eddy current, ultimately increasing the communication range of the antenna even more.

It is apparent that the present invention is not limited to the above embodiments, but may be modified and changed without departing from the scope and spirit of the invention.

In each embodiments described above, the antenna coil 12 is a spiral pattern composed of several turns. Nonetheless, it may be a loop pattern composed of less than one turn. That is, the antenna coil 12 may have a planer coil pattern shaped like either a loop or a spiral. The antenna coil 12 may be formed on the lower surface of the substrate 11, or on both surfaces of the substrate 11. The slit SL need not be a linear slit and may be curved or zig-zag slit. Moreover, the first, and second metal plates 20A and 20B may not be the thick metal layers constituting the housing, but may be metal foil bonded to the outer or inner surfaces of a resin case.

What is claimed is:

1. An antenna device comprising:
a first metal layer having a back surface and a first slit;
an antenna coil having a near end surface facing the back surface of the first metal layer and a far end surface opposite to the near end surface, the antenna coil having an inner diameter area overlapping with the first slit in planar view and a coil axis substantially perpendicular to the first metal layer; and
a first magnetic layer having an upper surface facing the back surface of the first metal layer, the first magnetic layer being provided outside the antenna coil in planar view,
wherein the upper surface of the first magnetic layer is positioned closer to the back surface of the first metal layer than the far end surface of the antenna coil, or is positioned in substantially the same plane as the far end surface of the antenna coil.

2. The antenna device as claimed in claim 1, wherein the upper surface of the first magnetic layer is bonded to the back surface of the first metal layer.

3. The antenna device as claimed in claim 1 further comprising a second magnetic layer facing the back surface of the first metal layer across the antenna coil.

4. The antenna device as claimed in claim 3, wherein the first magnetic layer is integrated with the second magnetic layer.

5. The antenna device as claimed in claim 1 further comprising a substrate arranged parallel to the first metal layer, wherein
the antenna coil is formed on an upper surface of the substrate which faces the back surface of the first metal layer, and
the second magnetic layer is formed on an lower surface of the substrate that is opposite to the upper surface thereof.

6. The antenna device as claimed in claim 1 further comprising a substrate arranged parallel to the first metal layer, wherein
the antenna coil is formed on an upper surface of the substrate,
the first magnetic layer is positioned without overlapping with the substrate in planar view, and
a lower surface of the first magnetic layer that is opposite to the upper surface thereof is located below the upper surface of the substrate.

7. The antenna device as claimed in claim 1 further comprising a second metal layer having a second slit, wherein
the antenna coil is provided between the first metal layer and the second metal layer, and
the inner diameter area of the antenna coil overlaps with the second slit in planar view.

8. The antenna device as claimed in claim 7, wherein a lower surface of the first magnetic layer opposite to the upper surface thereof is in contact with the second metal layer.

9. The antenna device as claimed in claim 1, wherein the first metal layer has a first metal plate, a second metal plate located adjacent to the first metal plate across the first slit, and a connecting portion extends over the slit to connect the first metal plate to the second metal plate such that the first and second metal plates are integrated.

10. The antenna device as claimed in claim 1, wherein the first metal layer is a housing of a mobile electronic apparatus that incorporates the antenna coil.

11. The antenna device as claimed in claim 1, wherein the first magnetic layer is a magnetic sheet containing flat metal grains.

12. An antenna device comprising:
a metal layer having a first area and a second area;
a magnetic layer covering the first area of the metal layer without covering the second area of the metal layer; and
an antenna coil having a coil axis substantially perpendicular to the metal layer,
wherein the metal layer has a slit that overlaps with an inner diameter area of the antenna coil, and
wherein the antenna coil faces the second area of the metal layer without facing the first area of the metal layer.

13. The antenna device as claimed in claim 12, wherein the silt separates the metal layer into a first metal plats and a second metal plate, each of the first, and second metal plates having the first and second areas.

14. The antenna device as claimed in claim 12, wherein the metal layer has a first metal plate, a second metal plate located adjacent to the first metal plate across the first slit, and a connecting portion extends over the slit to connect the first metal plate to the second metal plate such that the first and second metal plates are integrated, each of the first and second metal plates having the first and second areas.

15. The antenna device as claimed in claim 12, wherein the antenna coil is surrounded by the magnetic layer.

16. The antenna device as claimed in claim 12, further comprising:
a substrate having a first surface on which the antenna coil is provided and a second surface opposite to the first surface; and
another magnetic layer provided on the second surface of the substrate.
